(19) United States
(12) Patent Application Publication
(10) Pub. No.: US 2024/0395075 A1
(43) Pub. Date: Nov. 28, 2024

(54) SUPPORT SYSTEM, SUPPORT METHOD, AND SUPPORT PROGRAM

(71) Applicant: NEC Corporation, Minato-ku, Tokyo (JP)

(72) Inventors: Norihito OI, Tokyo (JP); Riki Eto, Tokyo (JP); Yuki Chiba, Tokyo (JP)

(73) Assignee: NEC Corporation, Minato-ku, Tokyo (JP)

(21) Appl. No.: 18/692,480

(22) PCT Filed: Oct. 11, 2021
(86) PCT No.: PCT/JP2021/037509

§ 371 Date: Mar. 15, 2024

(51) Int. Cl. G07C 5/00

(52) U.S. Cl. CPC G07C 5/006

(57) ABSTRACT

The input means 81 accepts input of observation data observed along with an operation of equipment and input of a cost function whose explanatory variable is a factor of action intended by equipment operator. The learning means 82 generates the cost function by inverse reinforcement learning using the observation data. The distribution map generation means 83 extracts weight of the explanatory variable of the generated cost function as a feature representing an intention of the operator, and generates a distribution map in which information on the cost function is placed at corresponding positions in a multidimensional space with the explanatory variables as dimensional axes according to the extracted feature.

### TECHNICAL FIELD

This invention relates to a support system, a support method, and a storage medium storing a support program to support in understanding intention of a user operating equipment.

### BACKGROUND ART

In order to have equipment automatically execute actions intended by users, it is necessary to guarantee quality of equipment that execute automatically by conducting tests that are assumed to be realistic. For example, in order to realize automated driving in the real world, it is necessary to guarantee the quality of automated driving by testing patterns that conform to the user's intentions.

Patent Literature 1 describes an intention feature extraction equipment for extracting a feature representing the subject's intention. The equipment described in Patent Literature 1 extracts weights of explanatory variables learned based on the subject's driving history as features representing the subject's driving intentions.

### CITATION LIST

### Patent Literature

PL 1: International Publication No. 2021/130916

### SUMMARY OF INVENTION

### Technical Problem

If one tries to perform all possible tests, there are many parameters to be considered to achieve automation, and the number of combinations of parameter settings is enormous, so a lot of time is required to manually create test scenarios. Therefore, in order to create test scenarios more efficiently, it is desirable to be able to accurately grasp the intentions of the user operating the equipment.

Therefore, it is an exemplary object of the present invention to provide a support system, a support method, and a support program that can support in understanding user intentions inferred from equipment observation data.

### Solution to Problem

The support system according to the present invention includes: an input means which accepts input of observation data observed along with an operation of equipment and input of a cost function whose explanatory variable is a factor of action intended by equipment operator; a learning means which generates the cost function by inverse reinforcement learning using the observation data; and a distribution map generation means which extracts weight of the explanatory variable of the generated cost function as a feature representing an intention of the operator, and generates a distribution map in which information on the cost function is placed at corresponding positions in a multidimensional space with the explanatory variables as dimensional axes according to the extracted feature.

The support method according to the present invention includes: accepting input of observation data observed along with an operation of equipment and input of a cost function whose explanatory variable is a factor of action intended by equipment operator; generating the cost function by inverse reinforcement learning using the observation data; and extracting weight of the explanatory variable of the generated cost function as a feature representing an intention of the operator, and generating a distribution map in which information on the cost function is placed at corresponding positions in a multidimensional space with the explanatory variables as dimensional axes according to the extracted feature.

A support program according to the present invention causes a computer to execute: an input process of accepting input of observation data observed along with an operation of equipment and input of a cost function whose explanatory variable is a factor of action intended by equipment operator; a learning process of generating the cost function by inverse reinforcement learning using the observation data; and a distribution map generation process of extracting weight of the explanatory variable of the generated cost function as a feature representing an intention of the operator, and generating a distribution map in which information on the cost function is placed at corresponding positions in a multidimensional space with the explanatory variables as dimensional axes according to the extracted feature.

### Advantageous Effects of Invention

According to the present invention, it is possible to support in understanding user intentions inferred from equipment observation data.

### BRIEF DESCRIPTION OF DRAWINGS

FIG. 1 It depicts a block diagram illustrating a configuration example of a first example embodiment of a support system according to the present invention.

FIG. 2 It depicts an explanatory diagram illustrating an example of observation data.

FIG. 3 It depicts an explanatory diagram illustrating an example of a learning process.

FIG. 4 It depicts an explanatory diagram illustrating an example of a distribution map.

FIG. 5 It depicts an explanatory diagram illustrating an example of clustering each cost function.

FIG. 6 It depicts a flowchart illustrating an operation example of the support system in the first example embodiment.

FIG. 7 It depicts a block diagram illustrating a configuration example of a second example embodiment of a support system according to the present invention.

FIG. 8 It depicts an explanatory diagram illustrating an example of a process of changing a feature.

FIG. 9 It depicts a flowchart illustrating an operation example of the support system in the second example embodiment.

FIG. 10 It depicts a block diagram illustrating an overview of the support system according to the present invention.

FIG. 11 It depicts a schematic block diagram illustrating a configuration of a computer according to at least one of example embodiments.

### DESCRIPTION OF EMBODIMENTS

The following is a description of the example embodiment of the invention with reference to the drawings.

### Example Embodiment 1

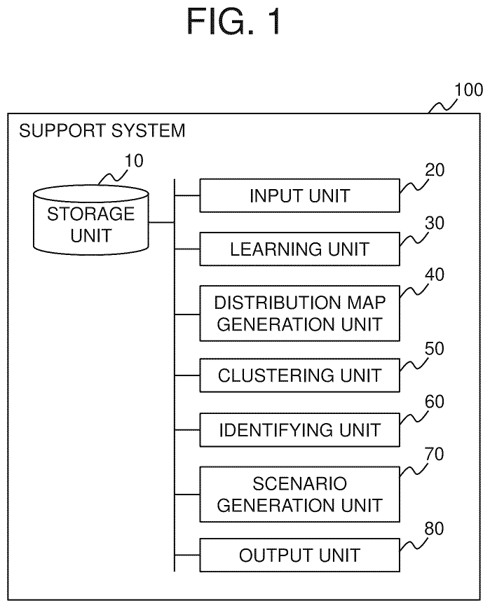

FIG. 1 is a block diagram illustrating a configuration example of a first example embodiment of a support system according to the present invention. The support system 100 in this example embodiment includes a storage unit 10, an input unit 20, a learning unit 30, a distribution map generation unit 40, a clustering unit 50, an identifying unit 60, a scenario generation unit 70, and an output unit 80.

The storage unit 10 stores various information used by the support system 100 for processing. For example, the storage unit 10 may store data used for learning by the learning unit 30 (described below) and cost functions generated as a result of learning. The storage unit 10 may also store other scenarios generated by the scenario generation unit 70. The storage unit 10 is realized, for example, by a magnetic disk.

The input unit 20 accepts input of information to be used for learning by the learning unit 30, which is described below. Specifically, the input unit 20 accepts input of data observed in observed along with an operation of equipment (hereinafter referred to as “observation data”). Here, the observation data includes not only data observed as a result of operating the equipment, but also data indicating the situation in which the equipment is operated, data indicating the situation or event that caused the equipment to be operated, and data indicating information set in the equipment to be operated. For example, if the equipment is a vehicle, the observation data is operational data that is observed in observed along with the operation of the vehicle.

The method of obtaining operation data and the contents of the operation data are arbitrary. For example, various data obtained by GPS (Global Positioning System) may be used as driving data. If images are taken during vehicle operation (e.g., front view, rear view, etc.), various information that can be extracted from the images may be used as driving data.

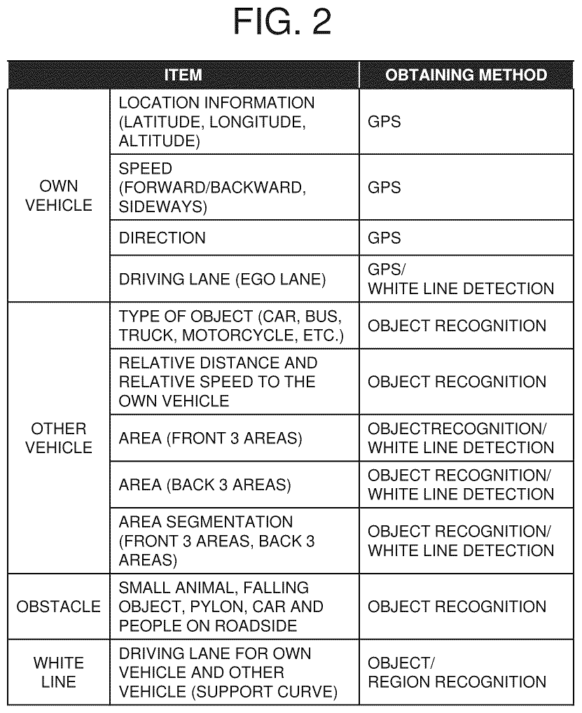

FIG. 2 is an explanatory diagram illustrating an example of observation data. In FIG. 2, driving data is illustrated as a specific example of observation data. For example, items of the own vehicle obtained from GPS include location information (latitude, longitude, altitude), speed (forward/backward, sideways), direction, and driving lane (ego lane). In addition, items of other vehicles obtained by object recognition, such as images, include the type of object (car, bus, truck, motorcycle, etc.), relative distance and relative speed to the own vehicle, and obstacles. White line detection techniques may also be used instead of or in conjunction with object recognition.

Thus, by using not only items for the own vehicle, but also items that indicate the relationship with other vehicles, it becomes possible to learn more appropriately the user's intention to be aware of other vehicles.

In this example embodiment, the case in which the input unit 20 accepts input of observation data is shown, but the learning unit 30, described below, may generate observation data from various types of information that is input.

The input unit 20 also accepts the input of a cost function that uses as explanatory variables the factors of the behavior intended by the operator of the equipment. This explanatory variable can be derived from observation data, and in the case of driving data, for example, corresponds to each of the items illustrated in FIG. 2. The explanatory variables are selected in advance by engineers, etc., and the cost function using these explanatory variables is also predetermined. An example of the cost function is, for example, a function expressed by a linear regression equation for each explanatory variable. The input unit 20 may also accept input of constraints for the cost function along with the cost function.

The learning unit 30 learns a cost function based on observation data. More specifically, the learning unit 30 learns the cost function that uses the factors of the operator's intended behavior as explanatory variables through inverse reinforcement learning using observation data. The method by which the learning unit 30 performs inverse reinforcement learning is arbitrary. For example, the learning unit 30 may generate a cost function using the method of inverse reinforcement learning described in PL 1. For example, if the equipment is a vehicle, the learning unit 30 generates the cost function by inverse reinforcement learning using driving data as described above.

The learning unit 30 may learn the cost function based on individual observation data, or may generate the cost function by inverse reinforcement learning using a group of observation data classified by similar attributes or situations. The learning unit 30 may generate the cost function using only one observation data with explicit attributes or situations.

For example, in the case of driving data, the learning unit 30 may learn the cost function for each group of operation data classified according to the surrounding driving conditions (e.g., cut-in, cut-out, etc.). By using classified observation data, or observation data with explicit attributes or situations, it is possible to easily grasp the operator's intentions that the cost function represents.

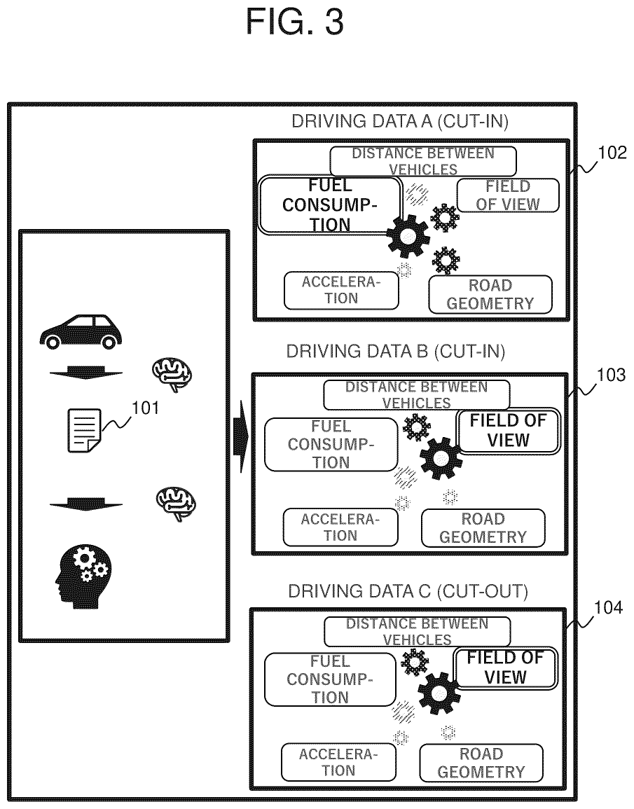

FIG. 3 is an explanatory diagram illustrating an example of a learning process. The example illustrated in FIG. 3 indicates that three observation data groups (driving data A, driving data B, and driving data C) were generated from driving data 101 acquired from real-world driving, and that cost function 102, cost function 103, and cost function 104 were generated for each observation data group. In the example illustrated in FIG. 3, each cost function includes fuel consumption, distance between vehicles, field of view, road geometry, and acceleration as explanatory variables, and the weight of the explanatory variable surrounded by a double frame is the highest.

As illustrated in FIG. 3, the driver's intention changes for each driving data. For example, the cost function 102, generated based on driving data A, indicates that the driver's intention is to emphasize fuel consumption, while the cost function 103 and the cost function 104 indicate that the driver's intention is to emphasize vision. This makes it possible to understand the driver's intention as represented by each cost function.

The distribution map generation unit 40 generates a distribution map in which information on the generated cost function is placed in a multidimensional space. Specifically, the distribution map generation unit 40 extracts weights of the explanatory variables of the generated cost function as a feature representing the intention of the operator. Then, the distribution map generation unit 40 generates a distribution map in which information on the cost function is placed at corresponding positions to the feature in the multidimensional space with the explanatory variables as dimensional axes according to the extracted feature.

The information about the cost function is arbitrary, as long as it is information that can be used to understand the contents of the cost function. The distribution map generation unit 40 may generate a distribution map in which the cost function itself is placed. For example, if the cost function is generated using data classified by attribute or situation, the distribution map generation unit 40 may generate a distribution map that places information indicating the attribute or situation as information about the cost function.

The information on the cost function is not limited to what is described above. For example, a distribution map may be generated in which identification numbers identifying the cost function, the cost function illustrated in FIG. 3, and the identification numbers of the cost function are placed.

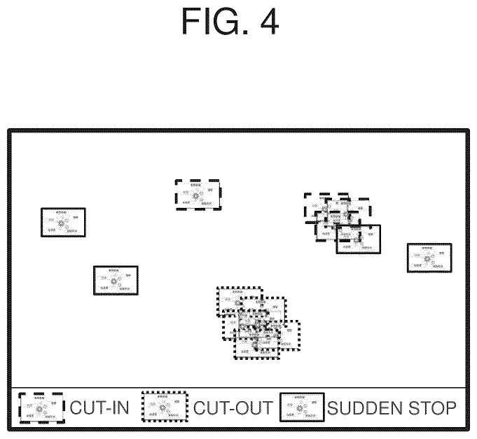

FIG. 4 is an explanatory diagram illustrating an example of a distribution map. The distribution map illustrated in FIG. 4 is a distribution map in which the cost functions illustrated in FIG. 3 are placed as information about the cost function. Specifically, the example illustrated in FIG. 4 represents that the cost functions indicating the driver's intention in the cut-out situation are arranged together, and the cost functions indicating the driver's intention in the cut-in situation are arranged together except for a part, and the cost function indicating the driver's intention in a sudden stop situation is distributed.

The distribution map illustrated in FIG. 4 represents the outer frame of information about the cost function in a manner that makes each situation identifiable. Other information, such as label information indicating the contents of each situation, may be placed in close proximity to the cost function.

The clustering unit 50 clusters each cost function using information about the placed cost functions. Specifically, the clustering unit 50 clusters each cost function based on the feature of the placed cost function. The method by which the clustering unit 50 groups the cost functions is not particularly limited, and any clustering method (non-hierarchical clustering, e.g., k-means) may be used.

The clustering unit 50 may reflect the results of clustering in the distribution map. The clustering unit 50 may, for example, surround the periphery of the information about the clustered cost functions or reflect a line or plane delimiting a region of multidimensional space in the distribution map, so that the clustered cost function group may be identified.

Note that the distribution map generation unit 40 labels the situation in which the observation data that was the basis for generating each cost function was obtained, so it is easier for the user to grasp the intended content of the boundary surface reflected by the clustering unit 50.

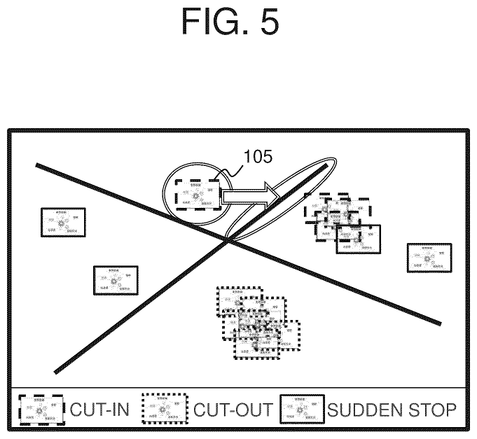

FIG. 5 is an explanatory diagram illustrating an example of clustering each cost function in the distribution map illustrated in FIG. 4. Specifically, FIG. 5 illustrates an example of a distribution map in which each clustered cost function is represented by a straight line separating them. The example illustrated in FIG. 5 indicates, for example, that cost function 105, which represents the driver's intention in a cut-out situation, represents different characteristics from the cost function indicating the driver's intention in a similar situation.

The identifying unit 60 identifies a predetermined characteristic cost function based on the results of clustering. Specifically, the identifying unit 60 identifies a typical cost function or rare cost function for each situation based on the results of clustering.

The identifying unit 60 may, for example, identify the center of each cluster as a typical cost function. Specifically, for example, if a cluster contains more than a predetermined percentage of cost functions that indicate similar situations, the identifying unit 60 may identify the cost function corresponding to the center of the cluster as the cost function that indicates the typical intention of the user in that situation. On the other hand, if the cluster contains less than a predetermined percentage of cost functions that indicate a certain situation, the identifying unit 60 may identify that cost function as a cost function that indicates a rare intention of the user in that situation.

Otherwise, the identification unit 60 may identify the cost function that is included in a cluster whose number of classifieds is less than a predetermined threshold, or the cost function that does not belong to any cluster among cost functions generated based on manually created scenarios (Functional Scenario) as a cost function that indicates a rare intention of the user. Further, the identifying unit 60 may identify the cost function that is close to the boundary surface as illustrated in FIG. 5 as a cost function that indicates a rare intention of the user. In other words, the identifying unit 60 may identify the cost function that is placed within a predetermined distance from a cluster boundary as a cost function that indicates a rare intention of the user.

It is further assumed that the cost function is generated by inverse reinforcement learning using a group of observation data classified by attribute or situation. In this case, the identifying unit 60 may identify the cost function that is not included in the cluster with the largest percentage of the cost functions generated from a group of observation data classified by the same attribute or situation as a cost function that indicates a rare intention of the user. The identifying unit 60 may also identify the cost function that is included in the clusters with a predetermined number or less of or less of cost function included in the classified clusters as a cost function that indicates a rare intention of the user.

The cost functions identified by the identifying unit 60 are not limited to rare and typical cost functions. The identifying unit 60 may, for example, identify cost functions that meet predetermined conditions.

The scenario generation unit 70 generates a scenario for the equipment using the identified cost function. The scenario of the equipment here means, for example, the operation of the equipment inferred using the identified cost function, and is the time-series data of the operation of the equipment in response to user operation. The scenario generation unit 70 may, for example, generate an equipment scenario by applying the identified cost function to a simulator.

Since scenarios are generated using the identified cost functions, this support system can be referred to as a scenario creation support system.

The output unit 80 outputs the distribution map generated by the distribution map generation unit 40 and the scenario generated by the scenario generation unit 70. The output unit 80 may, for example, display the distribution map on a display device (not shown) or store the generated scenario in the storage unit 10.

The input unit 20, the learning unit 30, the distribution map generation unit 40, the clustering unit 50, the identifying unit 60, the scenario generation unit 70, and the output unit 80 are realized by a processor (for example, CPU (Central Processing Unit), GPU (Graphics Processing Unit)) of a computer that operates according to a program (support program).

For example, a program may be stored in the storage unit 10 and the processor may read the program and operate as the input unit 20, the learning unit 30, the distribution map generation unit 40, the clustering unit 50, the identifying unit 60, the scenario generation unit 70, and the output unit 80 according to the program. In addition, each function of the input unit 20, the learning unit 30, the distribution map generation unit 40, the clustering unit 50, the identifying unit 60, the scenario generation unit 70, and the output unit 80 may be provided in the form of Saas (Software as a Service).

The input unit 20, the learning unit 30, the distribution map generation unit 40, the clustering unit 50, the identifying unit 60, the scenario generation unit 70, and the output unit 80 may each be realized by dedicated hardware. Some or all of the components of each device may be realized by general-purpose or dedicated circuit, a processor, or combinations thereof. These may be configured by a single chip or by multiple chips connected through a bus. Some or all of the components of each device may be realized by a combination of the above-mentioned circuit, etc., and a program.

When some or all of the components of the input unit 20, the learning unit 30, the distribution map generation unit 40, the clustering unit 50, the identifying unit 60, the scenario generation unit 70, and the output unit 80 are realized by multiple information processing devices, circuits, etc., the multiple information processing devices, circuits, etc. may be centrally located or distributed. For example, the information processing devices, circuits, etc. may be realized as a client-server system, a cloud computing system, etc., each of which is connected through a communication network.

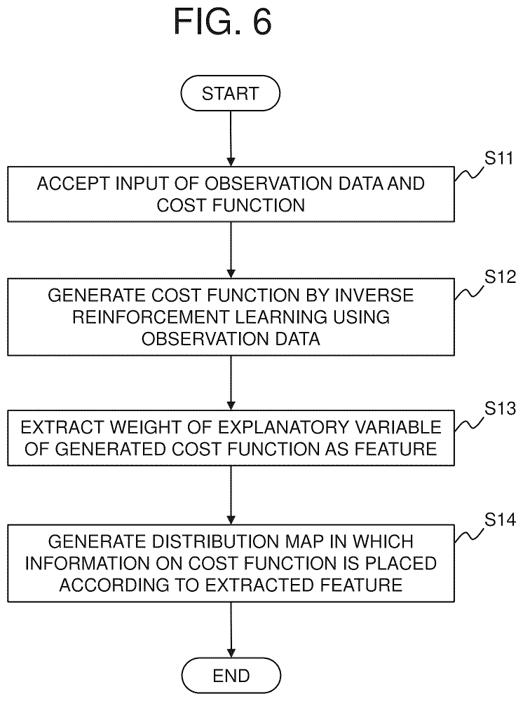

Next, the operation of this example embodiment of the support system will be described. FIG. 6 is a flowchart illustrating an operation example of the support system 100 in this example embodiment. The input unit 20 accepts input of observation data and a cost function (step S11). The learning unit 30 generates the cost function by inverse reinforcement learning using the observation data (step S12). The distribution map generation unit 40 extracts weights of explanatory variables of the generated cost function as a feature (Step S13). Then, the distribution map generation unit 40 generates a distribution map in which information on the cost function is placed at corresponding positions in a multidimensional space according to the extracted feature (Step S14).

As described above, in this example embodiment, the input unit 20 accepts input of observation data and a cost function, and the learning unit 30 generates the cost function by inverse reinforcement learning using the observation data. Then, the distribution map generation unit 40 extracts weights of explanatory variables of the generated cost function as feature, and generates a distribution map in which information on the cost function is placed at corresponding positions in a multidimensional space according to the extracted feature. Since the information about the cost function placed on the distribution map is information reflecting the user's intention, it can support in understanding the user's intention inferred from the equipment observation data.

### Example Embodiment 2

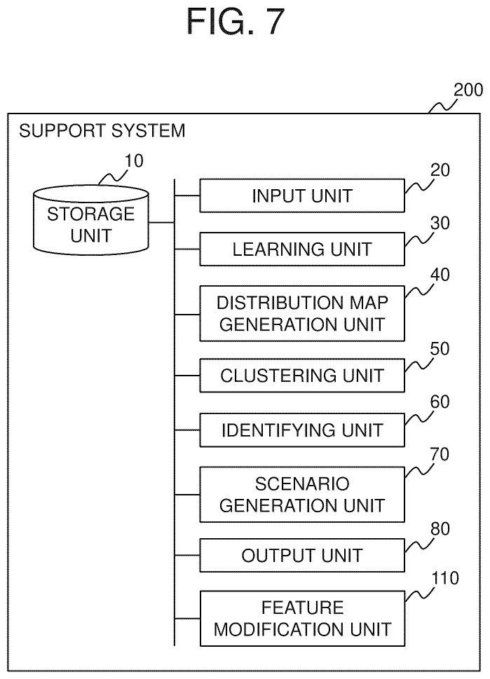

Next, a second example embodiment of the support system according to the present invention will be described. FIG. 7 is a block diagram illustrating a configuration example of a second example embodiment of a support system according to the present invention. The support system 200 of this example embodiment includes a storage unit 10, an input unit 20, a learning unit 30, a distribution map generation unit 40, a clustering unit 50, an identifying unit 60, a feature modification unit 110, a scenario generation unit 70, and an output unit 80.

In other words, the support system 200 of this example embodiment differs from the first example embodiment in that it is further equipped with the feature modification unit 110 compared to the support system 100 of the first example embodiment. Other configurations are similar to the first example embodiment.

The feature modification unit 110 modifies the feature of the cost function identified by the identifying unit 60. For example, if the cost function is represented by a linear regression equation of explanatory variables, the feature modification unit 110 modifies the weight of each explanatory variable. For example, the feature modification unit 110 may modify the weights (feature) of explanatory variables other than the explanatory variables of interest (emphasis). For example, it is assumed that among the explanatory variables of the cost function illustrated in FIG. 3, the feature is to be modified with emphasis on fuel consumption. In this case, the feature modification unit 110 may normalize the weights and modify features other than fuel consumption.

Thereafter, the process by which the scenario generation unit 70 generates scenarios for equipment using the cost function with modified features is the same as in the first example embodiment. That is, the scenario generation unit 70 generates scenarios for the equipment using the cost function with the modified features. In this way, it is possible to create the desired scenario from the cost function that indicates the intention of the focused operator.

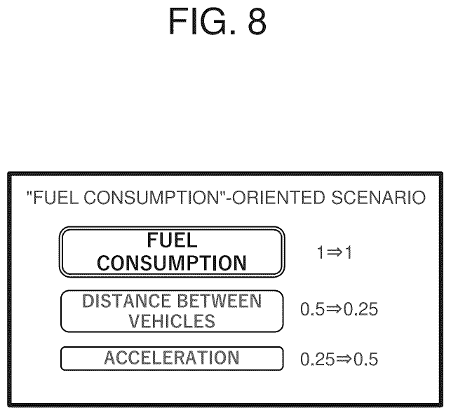

FIG. 8 is an explanatory diagram illustrating an example of a process of changing a feature. For example, it is assumed the case where a fuel consumption-oriented scenario is generated. First, the identifying unit 60 identifies a cost function that indicates the operator's intention to emphasize fuel consumption. At this time, the cost function 105 for rare cases may be identified, as illustrated in FIG. 5. Next, the feature modification unit 110 sets the weight of fuel consumption to 1 through normalization and modifies the weights of other explanatory variables as appropriate. The method by which the feature modification unit 110 modifies the weights is arbitrary, for example, by a fixed percentage, at a fixed interval, up to around a boundary value, and so on.

The scenario generation unit 70 then generates a scenario using the modified cost function. For example, by changing the features of the cost function for rare cases, it is possible to create many scenarios for rare cases.

The input unit 20, the learning unit 30, the distribution map generation unit 40, the clustering unit 50, the identifying unit 60, the feature modification unit 110, the scenario generation unit 70, and the output unit 80 are realized by a processor of a computer that operates according to a program (support program).

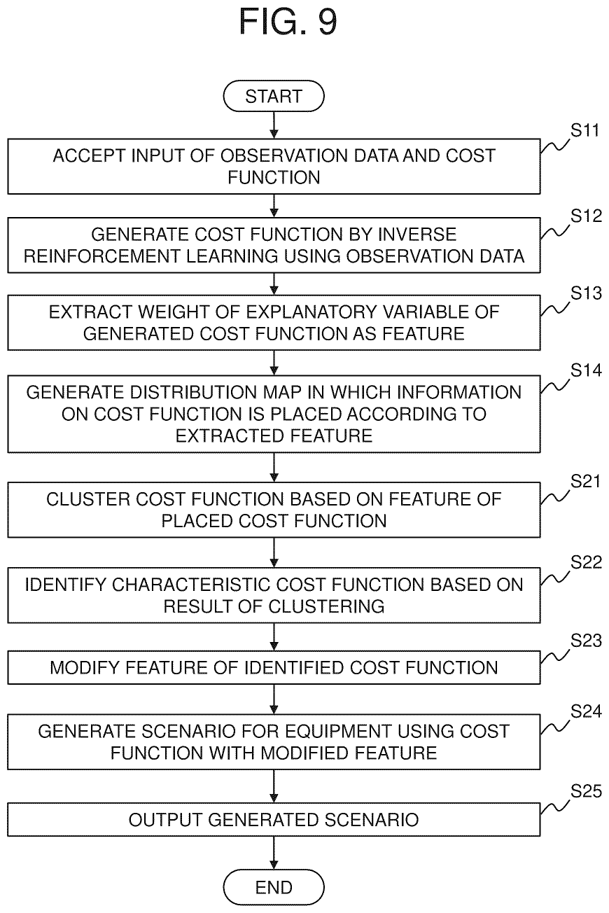

Next, the operation of this example embodiment of the support system will be described. FIG. 9 is a flowchart illustrating an operation example of the support system 200 in the second example embodiment. The process up to learning the cost function based on the observation data, extracting the features, and generating the distribution map is the same as the process from step S11 to step S14 illustrated in FIG. 6.

The clustering unit 50 clusters the cost functions based on the features of the placed cost function (step S21). The identifying unit 60 identifies a predetermined characteristic cost function based on the result of clustering (Step S22). The feature modification unit 110 modifies the feature of the identified cost function (step S23). The scenario generation unit 70 generates a scenario for the equipment using the cost function with the modified features (step S24). The output unit 80 outputs the generated scenario (step S25).

As described above, in addition to the configuration of the first example embodiment, in this example embodiment, the feature modification unit 110 modifies the feature of the cost function identified by the identifying unit 60, and the scenario generation unit 70 generates the scenario for the equipment using the cost function with the modified features. Thus, in addition to the effects of the first example embodiment, it is possible to create a number of scenarios assuming various cases based on the feature values of interest.

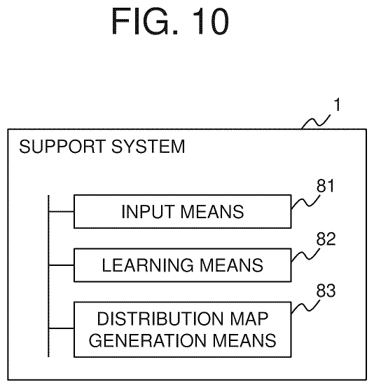

The following is an overview of the invention. FIG. 10 is a block diagram illustrating an overview of the support system according to the present invention. The support system 1 according to the present invention includes an input means 81 (e.g., the input unit 20) which accepts input of observation data observed along with an operation of equipment (e.g., driving a vehicle) and input of a cost function whose explanatory variable is a factor of action intended by equipment operator (e.g., the driver), a learning means 82 (e.g., the learning unit 30) which generates the cost function by inverse reinforcement learning using the observation data, and a distribution map generation means 83 (e.g., the distribution map generation unit 40) which extracts weight of the explanatory variable of the generated cost function as a feature representing an intention of the operator, and generates a distribution map in which information on the cost function is placed at corresponding positions in a multidimensional space with the explanatory variables as dimensional axes according to the extracted feature.

Such a configuration can support in understanding the user's intentions inferred from equipment observation data.

The support system 1 may also include a clustering means (e.g., the clustering unit 50) which clusters the cost function based on the feature of the placed cost function, and an identifying means (e.g., identifying unit 60) which identifies a predetermined characteristic cost function based on the results of the clustering.

Specifically, the identifying means may identify the cost function that is included in a cluster whose number of classifieds is less than a predetermined threshold, or the cost function that does not belong to any cluster. Such a configuration allows the identification of cost functions that indicate rare intent.

Otherwise, the identifying means may identify the cost function placed within a predetermined distance from a cluster boundary. Such a configuration allows the identification of rare cost functions that are far from the cluster center, even if the cost functions are in the same cluster.

The learning means 82 may generate the cost function by inverse reinforcement learning using a group of observation data classified by attribute or situation. Then, the identifying means may identify the cost function that is not included in a cluster with the largest percentage of cost functions generated from a group of observation data classified by the same attribute or situation, or the cost function that is included in a cluster with a predetermined number or less of cost functions included in the classified clusters. Such a configuration allows the identification of cost functions that indicate rare intentions for each attribute or situation.

On the other hand, the identifying means may identify the cost function corresponding to a center of the cluster. Such a configuration makes it possible to identify a typical cost function.

Here, the cost function may be defined by a linear regression equation of the explanatory variables.

The support system 1 may further includes a scenario generation means (e.g., scenario generation unit 70) which generates a scenario for the equipment using the identified cost function. Such a configuration makes it possible to generate a large number of scenarios for various cases.

Furthermore, the support system 1 may further include a feature modification means (e.g., feature modification unit 110) which modifies the feature of the cost function. Then, the scenario generation means may generate the scenario for the equipment using the cost function with the modified features. Such a configuration makes it possible to create a number of scenarios for various cases based on the feature values of interest.

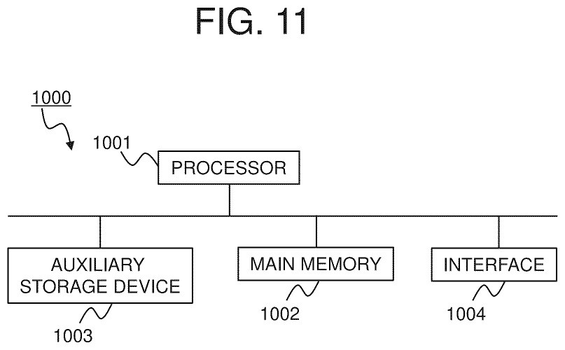

FIG. 11 is a schematic block diagram illustrating a configuration of a computer according to at least one of example embodiments. A computer 1000 includes a processor 1001, a main storage device 1002, an auxiliary storage device 1003, and an interface 1004.

The support system 1 described above is implemented in the computer 1000. Then, the operation of each processing unit described above is stored in the auxiliary storage device 1003 in the form of a program (support program). The processor 1001 reads the program from the auxiliary storage device 1003, develops the program in the main storage device 1002, and executes the above processing according to the program.

Note that, in at least one example embodiment, the auxiliary storage device 1003 is an example of a non-transitory tangible medium. Other examples of the non-transitory tangible medium include a magnetic disk, a magneto-optical disk, a compact disc read-only memory (CD-ROM), a digital versatile disk (DVD)-ROM, a semiconductor memory, and the like connected via the interface 1004. Furthermore, in a case where the program is distributed to the computer 1000 via a communication line, the computer 1000 that has received the program may develop the program in the main storage device 1002 and execute the above processing.

Furthermore, the program may be for implementing some of the functions described above. In addition, the program may be a program that implements the above-described functions in combination with another program already stored in the auxiliary storage device 1003, a so-called difference file (difference program).

Although some or all of the above example embodiments may also be described as in the following Supplementary notes, but not limited to the following.

(Supplementary note 1) A support system comprising:
an input means which accepts input of observation data observed along with an operation of equipment and input of a cost function whose explanatory variable is a factor of action intended by equipment operator;
a learning means which generates the cost function by inverse reinforcement learning using the observation data; and
a distribution map generation means which extracts weight of the explanatory variable of the generated cost function as a feature representing an intention of the operator, and generates a distribution map in which information on the cost function is placed at corresponding positions in a multidimensional space with the explanatory variables as dimensional axes according to the extracted feature.

(Supplementary note 2) The support system according to Supplementary note 1, further comprising:
a clustering means which clusters the cost function based on the feature of the placed cost function; and
an identifying means which identifies a predetermined characteristic cost function based on the results of the clustering.

(Supplementary note 3) The support system according to Supplementary note 2, wherein
the identifying means identifies the cost function that is included in a cluster whose number of classifieds is less than a predetermined threshold, or the cost function that does not belong to any cluster.

(Supplementary note 4) The support system according to Supplementary note 2 or 3, wherein
the identifying means identifies the cost function placed within a predetermined distance from a cluster boundary.

(Supplementary note 5) The support system according to any one of Supplementary notes 2 to 4, wherein
the learning means generates the cost function by inverse reinforcement learning using a group of observation data classified by attribute or situation, and
the identifying means identifies the cost function that is not included in a cluster with the largest percentage of cost functions generated from a group of observation data classified by the same attribute or situation, or the cost function that is included in a cluster with a predetermined number or less of cost functions included in the classified clusters.

(Supplementary note 6) The support system according to Supplementary note 2, wherein
the identifying means identifies the cost function corresponding to a center of the cluster.

(Supplementary note 7) The support system according to any one of Supplementary notes 1 to 6, wherein
the cost function is defined by a linear regression equation of the explanatory variables.

(Supplementary note 8) The support system according to any one of Supplementary notes 1 to 7, further comprising
a scenario generation means which generates a scenario for the equipment using the identified cost function.

(Supplementary note 9) The support system according to Supplementary note 8, further comprising
a feature modification means which modifies the feature of the cost function,
wherein the scenario generation means generates the scenario for the equipment using the cost function with the modified features.

(Supplementary note 10) A support method comprising:
accepting input of observation data observed along with an operation of equipment and input of a cost function whose explanatory variable is a factor of action intended by equipment operator;
generating the cost function by inverse reinforcement learning using the observation data; and
extracting weight of the explanatory variable of the generated cost function as a feature representing an intention of the operator, and generating a distribution map in which information on the cost function is placed at corresponding positions in a multidimensional space with the explanatory variables as dimensional axes according to the extracted feature.

(Supplementary note 11) The support method according to Supplementary note 10, further comprising:
clustering the cost function based on the feature of the placed cost function; and
identifying a predetermined characteristic cost function based on the results of the clustering.

(Supplementary note 12) A program storage medium which stores a support program for causing a computer to execute:
an input process of accepting input of observation data observed along with an operation of equipment and input of a cost function whose explanatory variable is a factor of action intended by equipment operator;
a learning process of generating the cost function by inverse reinforcement learning using the observation data; and
a distribution map generation process of extracting weight of the explanatory variable of the generated cost function as a feature representing an intention of the operator, and generating a distribution map in which information on the cost function is placed at corresponding positions in a multidimensional space with the explanatory variables as dimensional axes according to the extracted feature.

(Supplementary note 13) The program storage medium according to Supplementary note 12, wherein the support program is for further causing a computer to execute:
a clustering process of clustering the cost function based on the feature of the placed cost function; and
an identifying process of identifying a predetermined characteristic cost function based on the results of the clustering.

(Supplementary note 14) A support program for causing a computer to execute:
an input process of accepting input of observation data observed along with an operation of equipment and input of a cost function whose explanatory variable is a factor of action intended by equipment operator;
a learning process of generating the cost function by inverse reinforcement learning using the observation data; and
a distribution map generation process of extracting weight of the explanatory variable of the generated cost function as a feature representing an intention of the operator, and generating a distribution map in which information on the cost function is placed at corresponding positions in a multidimensional space with the explanatory variables as dimensional axes according to the extracted feature.

(Supplementary note 15) The support program according to Supplementary note 14, for further causing a computer to execute:
a clustering process of clustering the cost function based on the feature of the placed cost function; and
an identifying process of identifying a predetermined characteristic cost function based on the results of the clustering.

The above description of the present invention is with reference to the example embodiments, but the present invention is not limited to the above example embodiments. Various changes can be made in the composition and details of the present invention that can be understood by those skilled in the art within the scope of the present invention.

### REFERENCE SIGNS LIST

10 Storage unit
20 Input unit
30 Learning unit
40 Distribution map generation unit
50 Clustering unit
60 Identifying unit
70 Scenario generation unit
80 Output unit
100, 200 Support system
110 Feature modification unit

What is claimed is:

1. A support system comprising:
a memory storing instructions; and
one or more processors configured to execute the instructions to:
accept input of observation data observed along with an operation of equipment and input of a cost function whose explanatory variable is a factor of action intended by equipment operator;
generate the cost function by inverse reinforcement learning using the observation data; and
extract weight of the explanatory variable of the generated cost function as a feature representing an intention of the operator, and generate a distribution map in which information on the cost function is placed at corresponding positions in a multidimensional space with the explanatory variables as dimensional axes according to the extracted feature.

2. The support system according to claim 1, wherein the processor is configured to execute the instructions to:
cluster the cost function based on the feature of the placed cost function; and
identify a predetermined characteristic cost function based on the results of the clustering.

3. The support system according to claim 2, wherein the processor is configured to execute the instructions to identify the cost function that is included in a cluster whose number of classifieds is less than a predetermined threshold, or the cost function that does not belong to any cluster.

4. The support system according to claim 2, wherein the processor is configured to execute the instructions to identify the cost function placed within a predetermined distance from a cluster boundary.

5. The support system according to claim 2, wherein the processor is configured to execute the instructions to:
generate the cost function by inverse reinforcement learning using a group of observation data classified by attribute or situation; and
identify the cost function that is not included in a cluster with the largest percentage of cost functions generated from a group of observation data classified by the same attribute or situation, or the cost function that is included in a cluster with a predetermined number or less of cost functions included in the classified clusters.

6. The support system according to claim 2, wherein the processor is configured to execute the instructions to identify the cost function corresponding to a center of the cluster.

7. The support system according to claim 1, wherein
the cost function is defined by a linear regression equation of the explanatory variables.

8. The support system according to claim 1, further comprising
a scenario generation means which generates a scenario for the equipment using the identified cost function.

9. The support system according to claim 8, wherein the processor is configured to execute the instructions to:
modify the feature of the cost function; and
generate the scenario for the equipment using the cost function with the modified features.

10. A support method comprising:
accepting input of observation data observed along with an operation of equipment and input of a cost function whose explanatory variable is a factor of action intended by equipment operator;
generating the cost function by inverse reinforcement learning using the observation data; and
extracting weight of the explanatory variable of the generated cost function as a feature representing an intention of the operator, and generating a distribution map in which information on the cost function is placed at corresponding positions in a multidimensional space with the explanatory variables as dimensional axes according to the extracted feature.

11. The support method according to claim 10, further comprising:
clustering the cost function based on the feature of the placed cost function; and
identifying a predetermined characteristic cost function based on the results of the clustering.

12. A non-transitory computer readable information recording medium which stores a support program, when executed by a processor, that performs a method for:
accepting input of observation data observed along with an operation of equipment and input of a cost function whose explanatory variable is a factor of action intended by equipment operator;
generating the cost function by inverse reinforcement learning using the observation data; and
extracting weight of the explanatory variable of the generated cost function as a feature representing an intention of the operator, and generating a distribution map in which information on the cost function is placed at corresponding positions in a multidimensional space with the explanatory variables as dimensional axes according to the extracted feature.

13. The non-transitory computer readable information recording medium according to claim 12, wherein the support program further performs a method for:
clustering the cost function based on the feature of the placed cost function; and
identifying a predetermined characteristic cost function based on the results of the clustering.
